(19) United States
(12) Patent Application Publication
(10) Pub. No.: US 2006/0037055 A1
(43) Pub. Date: Feb. 16, 2006

(54) Audio data communication system, audio data transmission apparatus, audio data reception apparatus, composite data communication system, composite data transmission apparatus and composite data reception apparatus

(75) Inventors: Hideyuki Hashimoto, Toyokawa-shi (JP); Kazuyuki Kawabata, Toyokawa-shi (JP); Takeshi Hibino, Toyokawa-shi (JP)

Correspondence Address: Barry E. Bretschneider;Morrison & Foerster LLP, Suite 300, 1650 Tysons Boulevard, McLean, VA, 22102, US

(73) Assignee: Konica Minolta Business Technologies, Inc., Chiyoda-ku (JP)

(21) Appl. No.: 10/984,997

(22) Filed: Nov. 10, 2004

(30) Foreign Application Priority Data
Aug. 4, 2004 (JP) 2004-228148

(51) Int. Cl. H04N 7/173

(52) U.S. Cl. 725/86

(57) ABSTRACT

When an MFP receives an e-mail to which audio data is attached, an audio data storing unit and a control information storing unit in the MFP respectively store the audio data and control information related to the audio data. When the MFP receives a playback instruction of the audio data through an operation panel unit, a security processing unit compares a security level of the MFP stored in an environment information storing unit with a security level indicated by the control information. When the security level of the MFP is higher, a speaker unit in the MFP normally plays back the audio data. When the security level of the MFP is lower, the audio data is played back in accordance with an alternative playback method indicated by the control information.

### CROSS-REFERENCE TO RELATED APPLICATIONS

This application is based on application No. 2004-228148 filed in Japan, the contents of which are hereby incorporated by reference.

### BACKGROUND OF THE INVENTION

(1) Field of the Invention

The present invention relates to a technique to transmit and receive audio data. The present invention particularly relates to a technique to protect the security of audio data while played back.

(2) Related Art

As the Internet has advanced and become widespread, an Internet facsimile (fax) system has recently been developed and been increasingly used. According to such an Internet fax system, image data is attached to an e-mail, and transmitted (see ITU-T recommendation T.37: Procedures for the transfer of facsimile data via store and forward on the Internet). In addition to the image data, audio data can be also attached to the e-mail to be transmitted. The following are, as an example, some techniques to transmit and receive a combination of image data and audio data.

U.S. Pat. No. 5,802,179 discloses the following technique. Image data showing characters, drawing figures and the like is printed on paper. In addition, a two-dimensional barcode showing audio data related to the image data is printed on the paper. The image data and the two-dimensional barcode printed on the paper are read so that the image data is displayed. Furthermore, when a designation of a location in the image data which is being displayed is received, audio data related to the location is output as a sound.

Furthermore, Japanese unexamined patent application publication No. H07-203100 discloses the following technique. Image data and audio data are combined together and encoded, to generate composite data. The composite data is faxed to a destination. At the destination, while the image data is decoded and printed out, the audio data is decoded and output as a sound.

These techniques, however, have a problem. A fax device is shared by a plurality of persons in many cases. If received audio data is output as a sound at a receiving fax device, a person who is not an intended receiver of the audio data may be able to hear the sound. This may lead to leakage of confidential information or invasion of the privacy of the intended receiver

### SUMMARY OF THE INVENTION

In view of the above problem, an object of the present invention is to provide an audio data communication system, an audio data transmission apparatus, an audio data reception apparatus, a composite data communication system, a composite data transmission apparatus, and a composite data reception apparatus, which can protect the security of audio data that is faxed.

The above object can be achieved by an audio data communication system including a transmission apparatus and a reception apparatus. Here, the transmission apparatus includes a generating unit operable to generate control information indicating a condition to play back audio data; and a transmitting unit operable to transmit the audio data and the control information. The reception apparatus includes a receiving unit operable to receive the audio data and the control information; a determination unit operable to determine a method to play back the audio data, based on the condition indicated by the control information and a security level of the reception apparatus; and a playback unit operable to play back the audio data in accordance with the method determined by the determination unit.

This construction can protect the security of the audio data which is faxed. Here, the audio data may include audio information only, or audio information combined with other types of data, for example, multimedia data including audio data.

The audio data communication system may be utilized in the following cases. When a problem occurs in a multi-functional peripheral (MFP) having an Internet fax function, abnormal noise which is thought to be related to the problem may be recorded and faxed along with a problem report. Furthermore, when a sales representative faxes a notice of transfer to his/her clients, the sales representative may desire to attach audio data to the notice.

In these cases, there is a risk of information leakage, if the fax (the problem report or the notice) is transmitted to a wrong destination and the attached audio data is played back normally. The present invention is applicable to prevent such information leakage, as the security level of the reception apparatus is referred. Here, the security level is a predetermined parameter which may be input by a manager of the reception apparatus, or determined based on an operation history of the reception apparatus as described later. This parameter preferably indicates a degree of likelihood that information included in the audio data is leaked when the audio data is played back.

Here, the reception apparatus further includes a determining unit operable to determine a forwarding destination of the audio data, based on the control information and the security level of the reception apparatus; and a forwarding unit operable to forward the audio data to the forwarding destination. This construction enables the audio data to be forwarded when the security level of the reception apparatus is not high enough. As a result, information leakage can be prevented.

Here, the reception apparatus may further includes a storing unit operable to store the audio data, if the forwarding unit fails to forward the audio data. This construction prevents the audio data from being lost, even if the reception apparatus fails to forward the audio data. In this case, the reception apparatus may attempt to forward the audio data again when a predetermined time period has elapsed after the failure. According to this construction, even if the reception apparatus fails to forward the audio data due to poor communication environment, the reception apparatus can successfully forward the audio data after the communication environment improves.

Here, the playback unit is permitted to play back the audio data when a predetermined time period has elapsed after the failure. This construction enables the audio data to be played back even after the reception apparatus fails to forward the audio data.

Here, the playback unit is permitted to play back the audio data, if an amount of audio data stored in the storing unit exceeds a predetermined amount. This construction enables the audio data to be played back, when the amount of data stored in the storing unit exceeds the predetermined amount and audio data stored in the storing unit needs to be deleted.

Here, the reception apparatus deletes the audio data from the storing unit when a predetermined time period has elapsed after the failure. This construction deletes audio data which is so old that it is no longer important. As a result, a memory area of the storing unit is not wasted.

Here, when an amount of audio data stored in the storing unit exceeds a predetermined amount, the reception apparatus deletes audio data which is the least recently stored in the storing unit. This construction makes it possible to keep audio data as long as the storing unit has a sufficient available capacity. As a result, audio data is not deleted to be played back as long as the storing unit has a sufficient available capacity.

Here, when an amount of audio data stored in the storing unit exceeds a predetermined amount, the reception apparatus stops receiving audio data. This construction can solve the following problem. If the reception apparatus receives audio data despite of a shortage of an available capacity, the received audio data may be lost. Here, when the reception apparatus does not receive audio data for this reason, a transmitter of the audio data is informed that the audio data has not been successfully transmitted. Thus, the transmitter can retry to transmit the audio data to a different reception apparatus.

Here, if the receiving unit receives only the audio data, the forwarding unit forwards the received audio data to a predetermined forwarding destination. This construction causes the reception apparatus to forward the audio data, when the reception apparatus receives the audio data without control information and therefore can not determine how to alternatively play back the audio data. As a result, leakage of information included in the audio data is less likely.

The reception apparatus may forward the audio data even when the audio data is transmitted along with control information. This happens when the reception apparatus can not play back the audio data in accordance with an alternative playback method that is determined based on the control information, or when the reception apparatus receives the audio data from a transmitter other than a predetermined transmitter.

Here, the forwarding destination is a mobile telephone. This construction makes it hard for other people to hear a sound played back based on the audio data. As a result, information leakage can be prevented. Here, the mobile telephone is a telephone that makes a call by means of radio communication, which can be any of line communication, packet communication and Internet Protocol (IP) phone communication.

Here, the transmission apparatus further includes a recording unit operable to record the audio data. Here, the recording unit is removable from the transmission apparatus. This construction enables the audio data to be recorded with more ease.

Here, it is preferable the control information indicates at least one of a location at which the audio data is permitted to be played back, an apparatus at which the audio data is permitted to be played back, a time at which the audio data is permitted to be played back, volume at which the audio data is permitted to be played back, speed at which the audio data is permitted to be played back, a register in which the audio data is permitted to be played back, and a part of the audio data which is permitted to be played back.

The object can be also achieved by an audio data transmission apparatus including: a generating unit operable to generate control information indicating a condition to play back audio data; and a transmitting unit operable to transmit the audio data and the control information, and an audio data reception apparatus including: a receiving unit operable to receive audio data and control information indicating a condition to play back the audio data; a determination unit operable to determine a method to play back the audio data, based on the condition indicated by the control information and a security level of the reception apparatus; and a playback unit operable to play back the audio data in accordance with the method determined by the determination unit. Thus, information leakage caused due to normal playback of audio data can be prevented for the reasons stated above.

The object can be also achieved by a composite data communication system for composite data including a combination of image data and audio data. Here, the composite data communication system includes a transmission apparatus and a reception apparatus. The transmission apparatus includes: a generating unit operable to generate control information indicating a condition to play back audio data included in composite data; and a transmitting unit operable to transmit the composite data and the control information. The reception apparatus includes: a receiving unit operable to receive the composite data and the control information; a determination unit operable to determine a method to play back the audio data, with reference to the condition indicated by the control information and a security level of the reception apparatus; and a playback unit operable to play back the audio data in accordance with the method determined by the determination unit. Here, the transmitting unit attaches image data included in the composite data, to an e-mail in accordance with an Internet fax standard, attaches the audio data included in the composite data and the control information to the e-mail, and transmits the e-mail to the reception apparatus, and the receiving unit receives the e-mail in accordance with the Internet fax standard. In the present description, the Internet fax standard is a standard defined in the following document:

ITU-T recommendation T.37: Procedures for the transfer of facsimile data via store and forward on the Internet.

The above construction can protect the security of audio data that is combined with image data to be faxed. Audio data can convey an intention of a transmitter of the fax (nuance between lines) more accurately than a written text. Here, when a person sends information to someone else and asks him/her to distribute the information, the person can attach audio data which includes instructions to distribute the information and explanation on the information. Thus, the instructions and the explanation are prevented from being distributed along with the information by mistake.

The above object can be achieved by a composite data transmission apparatus that transmits composite data including a combination of image data and audio data. The composite data transmission apparatus includes: a generating unit operable to generate control information indicating a condition to play back audio data included in composite data; and a transmitting unit operable to transmit the composite data and the control information. Here, the transmitting unit attaches image data included in the composite data, to an e-mail in accordance with an Internet fax standard, attaches the audio data included in the composite data and the control information to the e-mail, and transmits the e-mail to the reception apparatus.

The above object can be achieved by a composite data reception apparatus that receives composite data including a combination of image data and audio data. The composite data reception apparatus includes: a receiving unit operable to receive composite data and control information indicating a condition to play back audio data included in the composite data; a determination unit operable to determine a method to play back the audio data, based on the condition indicated by the control information and a security level of the reception apparatus; and a playback unit operable to play back the audio data in accordance with the method determined by the determination unit. Here, the receiving unit receives the e-mail in accordance with the Internet fax standard.

Note that an Internet fax apparatus to which the present invention is applied may have an IP phone function.

### BRIEF DESCRIPTION OF THE DRAWINGS

These and other objects, advantages and features of the invention will become apparent from the following description thereof taken in conjunction withthe accompanying drawings those illustrate a specific embodiments of the invention.

In the drawings:

FIG. 1 illustrates a construction of a fax system relating to a first embodiment;

FIG. 2 is a functional block diagram illustrating main components of an MFP 10a relating to the first embodiment;

FIG. 3 is a flow chart illustrating an operation executed by the MFP 10a relating to the first embodiment to transmit a fax;

FIG. 4 is a flow chart illustrating a fax transmission operation (S108 in FIG. 3) performed by the MFP 10a relating to the first embodiment;

FIG. 5 is a flow chart illustrating an operation performed by the MFP 10a relating to the first embodiment to receive a fax;

FIG. 6 is a flowchart illustrating a playback operation (S311 in FIG. 5) performed by the MFP 10a relating to the first embodiment;

FIG. 7 is a flow chart illustrating a transmission operation performed by a mobile telephone 19a relating to the first embodiment;

FIG. 8 is a functional diagram illustrating main components of an MFP 30 relating to a second embodiment;

FIG. 9 is a flow chart illustrating an operation relating to a playback of a sound which is performed by the MFP 30 relating to the second embodiment;

FIG. 10 illustrates a forwarding destination table stored in a forwarding destination storage unit 317 (shown in FIG. 8) relating to a second embodiment;

FIG. 11 illustrates an alternative playback method indicated by control information relating to a second modification example;

FIG. 12 illustrates a security level determination table which is used to determine a security level based on an operation history of an MFP, in a third modification example; and

FIG. 13 is a functional block diagram illustrating main components of an MFP 40 relating to an eleventh modification example.

### DESCRIPTION OF PREFERRED EMBODIMENTS

The following describes an audio data communication system, an audio data transmission apparatus, an audio data reception apparatus, a composite data communication system, a composite data transmission apparatus and a composite data reception apparatus relating to embodiments of the present invention. The following description is made using an Internet fax system (hereinafter referred to as a fax system) as an example, with reference to the attached drawings.

### 1. First Embodiment

1.1 Construction of a Fax System

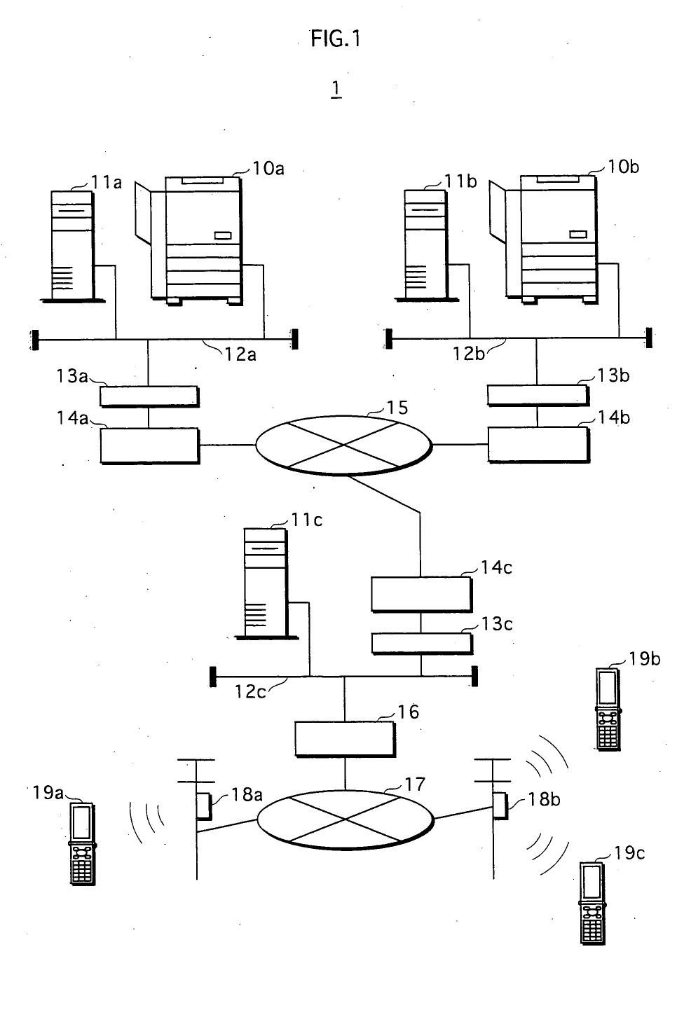

The following part describes a construction of a fax system relating to a first embodiment of the present invention. FIG. 1 illustrates the construction of the fax system relating to the first embodiment. As shown in FIG. 1, a fax system 1 includes multi-functional peripherals (MFPS) 10a and 10b, e-mail servers 11a to 11c, local area networks (LANS) 12a to 12c, fire walls 13a to 13c, routers 14a to 14c, the Internet 15, a gateway 16, a telephone network 17, base stations 18a and 18b, and mobile telephones 19a to 19b.

The MFP 10a, the e-mail server 11a, the fire wall 13a, and the router 14a are connected together by the LAN 12a, to form a privately-owned network. Similarly, the MFP 10b, the e-mail server 11b, the fire wall 13b, and the router 14b are connected together by the LAN 12b, to form a privately-owned network.

The e-mail server 11c, the fire wall 13c, the router 14c and the gateway 16 are connected together by the LAN 12c, to form a privately-owned network. The gateway 16 connects this privately-owned network to the telephone network 17. Thus, an e-mail can be exchanged between the privately-owned network and the telephone network 17.

The base stations 18a and 18b are connected to the telephone network 17. The base stations 18a and 18b receive/transmit an e-mail from/to the mobile telephones 19a to 19c through the telephone network 17. The numbers of MFPs, e-mail servers, and mobile telephones in the fax system 1 are not limited to those mentioned above.

1.2 Construction of the MFPs 10a and 10b

The following part describes a construction of the MFP 10a. The following description also serves as an explanation for a construction of the MFPs 10b, since the MFP 10b has the same construction as the MFP 10a.

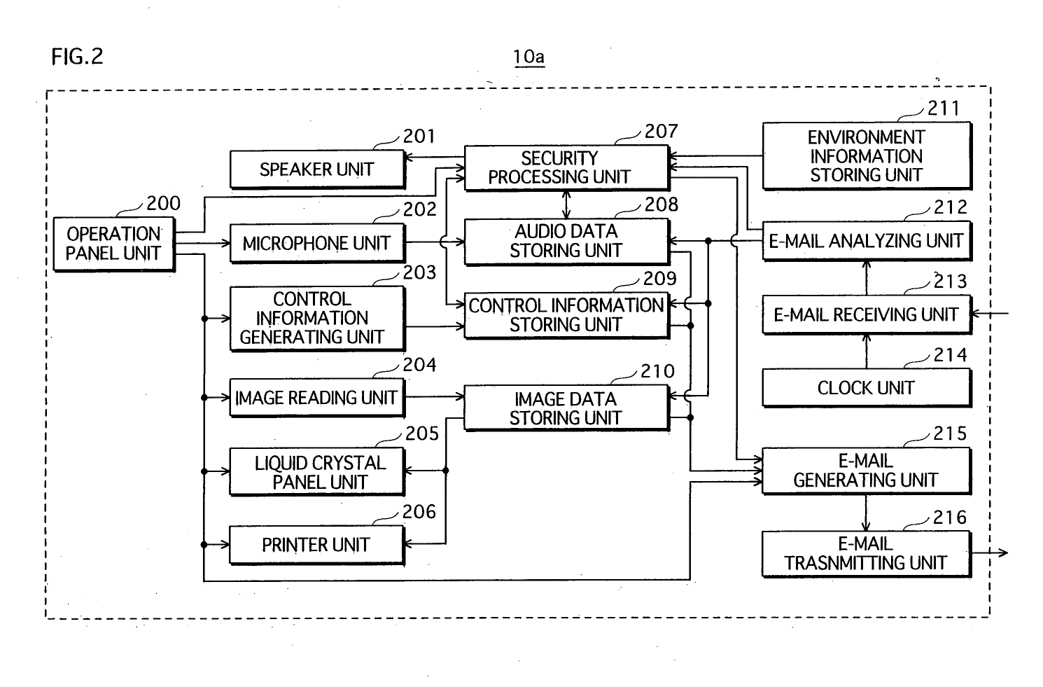

FIG. 2 is a functional block diagram illustrating the construction of the MFP 10a. As shown in FIG. 2, the MFP 10a includes an operation panel unit 200, a speaker unit 201, a microphone unit 202, a control information generating unit 203, an image reading unit 204, a liquid crystal panel unit 205, a printer unit 206, a security processing unit 207, an audio data storing unit 208, a control information storing unit 209, an image data storing unit 210, an environment information storing unit 211, an e-mail analyzing unit 212, an e-mail receiving unit 213, a clock unit 214, an e-mail generating unit 215, and an e-mail transmitting unit 216.

The operation panel unit 200 has a function of receiving an input from a user of the MFP 10a. The operation panel unit 200 includes, for example, a small-sized liquid crystal panel or a numeric keypad, and receives an instruction to transmit a fax, an instruction to record a sound and the like.

The image reading unit 204 has a function of reading image data from a document. The image reading unit 204 generates digital image data (hereinafter simply referred to as image data) in the following manner. The image reading unit 204 scans, using a scanner, a document which is fed from a document tray to a platen by an automatic document feeder (ADF). The image reading unit 204 then converts light reflected by the document into an electrical signal by using a charge coupled device (CCD) sensor, to obtain image data. Furthermore, the image reading unit 204 performs image processing on the image data. The image processing includes shading correction, reflectivity-density conversion, MTF correction, density correction, and thresholding such as error diffusion. Moreover, the image reading unit 204 performs data compression on the image data.

The image data storing unit 210 has a function of storing the image data generated by the image reading unit 204. The image data storing unit 210 also stores image data attached to an e-mail received by the MFP 10a.

The liquid crystal panel unit 205 has a function of displaying the image data stored in the image data storing unit 210 according to an instruction from the operation panel unit 200. The printer unit 206 has a function of printing the image data stored in the image data storing unit 210 according to an instruction from the operation panel unit 200.

The microphone unit 202 has a function of generating digital audio data (hereinafter simply referred to as audio data) by converting a sound into an electrical signal according to an instruction from the operation panel unit 200. The microphone unit 202 may convert the electrical signal into a digital signal by pulse code modulation (PCM), and then compress the digital signal into a format in conformity with the MPEG audio layer-3 (MP3) standard, WAV format, or WMA format.

The audio data storing unit 208 has a function of storing the audio data generated by the microphone unit 202. The audio data storing unit 208 also stores audio data attached to an e-mail received by the MFP 10a.

The e-mail generating unit 215 generates an e-mail according to an instruction from the operation panel unit 200. Here, the e-mail generating unit 215 attaches the image data stored in the image data storing unit 210 to the e-mail, in conformity with an Internet fax standard. The e-mail generating unit 215 attaches, to the e-mail, the audio data stored in the audio data storing unit 208 according to an instruction from the operation panel unit 200. In this case, the e-mail generating unit 215 attaches control information, to thee-mail, in relation with the audio data. The control information is stored in the control information storing unit 209.

The e-mail transmitting unit 216 has a function of transmitting the e-mail generated by the e-mail generating unit 215. The e-mail transmitting unit 216 transmits the e-mail to the e-mail server 11a in accordance with the Simple Mail Transfer Protocol (SMTP), RFC821.

The control information generating unit 203 has a function of generating the control information that is attached to the e-mail together with the audio data.

The control information storing unit 209 has a function of storing the control information generated by the control information generating unit 203, in relation with the audio data stored in the audio data storing unit 208. The control information storing unit 209 also stores control information attached to an e-mail received by the MFP 10a, in relation with audio data that is attached to the received e-mail.

The e-mail receiving unit 213 has a function of receiving a notice from the clock unit 214 at regular time intervals. The e-mail receiving unit 2.13 also has a function of receiving an e-mail which is addressed to the MFP 10a from the e-mail server 11a in accordance with the post office protocol version 3 (POP3), RFC1939. The clock unit 214 has a timer, and sends a notice to the e-mail receiving unit 213 at predetermined time intervals.

The e-mail analyzing unit 212 has a function of analyzing the e-mail received by the e-mail receiving unit 213, and retrieving image data, audio data and control data attached to the e-mail. The image data, audio data and control data are respectively stored in the image data storing unit 210, the audio data storing unit 208 and the control information storing unit 209, in relation with each other.

The environment information storing unit 211 stores environment information regarding the MFP 10a.

The security processing unit 207 retrieves control information which is related to audio data designated by the operation panel unit 200, from the control information storing unit 209. Furthermore, the security processing unit 207 causes the speaker unit 201 to output the audio data as a sound, in an alternative playback method determined by the control information and the environment information.

1.3 Operations of the MFP 10a

The following part describes operations of the MFP 10a. The following description also serves as an explanation for operations of the MFP 10b, since its operations are the same as the operations of the MFP 10a.

(1) Transmitting a Fax

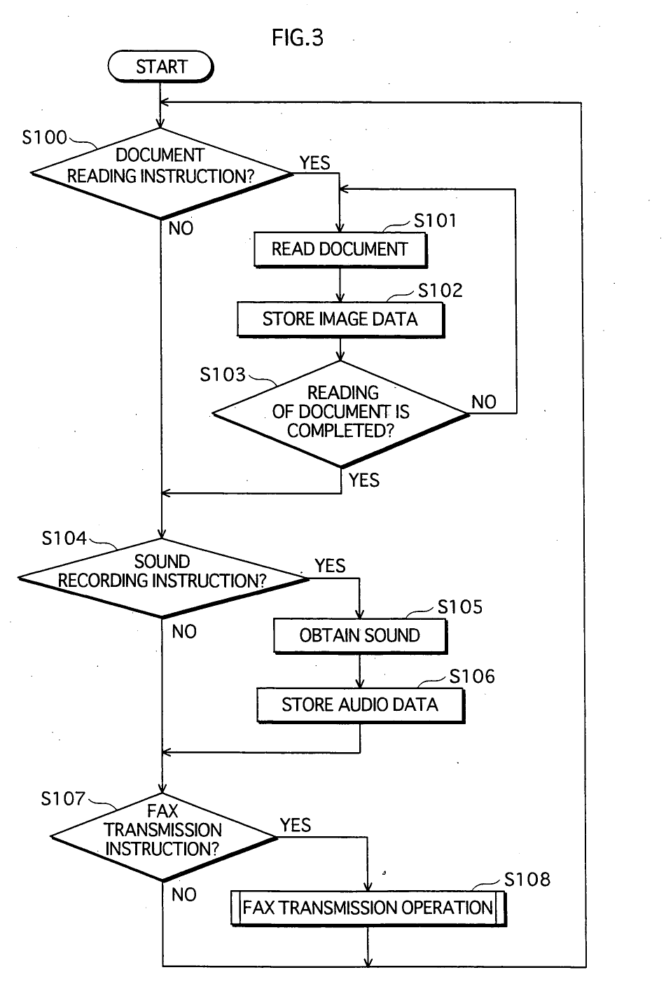

The following part describes an operation performed by the MFP 10a to transmit a fax. FIG. 3 is a flowchart illustrating the operation performed by the MFP 10a to transmit a fax. As shown in FIG. 3, when the MFP 10a receives a document reading instruction from the user through the operation panel unit 200 (S100:YES), the image reading unit 204 reads a document (S101). The image data storing unit 210 stores image data obtained by reading the document (S102).

When the MFP 10a has not completed the reading of the document (S103:NO), the MFP 10a repeats steps S101 and S102.

When the image reading unit 204 has completed the reading of the document according to the document reading instruction (S103:YES), the operation proceeds to a step S104. When the MFP 10a receives a sound recording instruction from the user through the operation panel unit 200 (S104:YES), the microphone unit 202 obtains a sound and converts the sound into an electrical signal, to generate audio data (S105). The audio data storing unit 208 stores the generated audio data in relation with the image data obtained in the step S101 (S106).

When receiving a fax transmission instruction from the user through the operation panel unit 200 (S107:YES), the MFP 10a performs a fax transmission operation for the image data (s108).

(1-1) Fax Transmission Operation (S108)

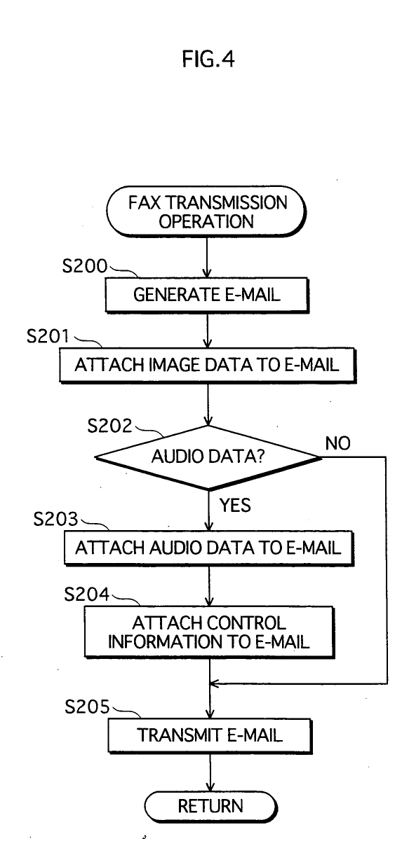

The following part describes the fax transmission operation in detail. FIG. 4 is a flow chart illustrating the fax transmission operation performed by the MFP 10a. As shown in FIG. 4, the e-mail generating unit 215 in the MFP 10a generates an e-mail in which a destination designated by the user is written in a “To” field of a mail header (S200). The MFP 10a then reads the image data obtained in the step S101 from the image data storing unit 210, and attaches the image data to the e-mail generated in the step S200 (S201).

If the audio data storing unit 208 stores audio data which is related to the image data (S202:YES), the e-mail generating unit 215 reads corresponding audio data from the audio data storing unit 208. At the same time, the e-mail generating unit 215 reads control information related to the audio data from the control information storing unit 209, and attaches the control information to the e-mail (S203 and S204).

After the audio data and the control information are attached to the e-mail, or if no audio data is related to the image data (S202:NO), the e-mail transmitting unit 216 in the MFP 10a transmits the e-mail (S205). Then, the operation goes back to a main routine.

Regarding control information, the MFP 10a may receive control information from the user whenever the MFP 10a records a sound. Alternatively, the MFP 10a may receive control information from the user whenever the MFP 10a performs a fax transmission operation. Furthermore, the MFP 10a may automatically generate control information depending on a destination of audio data, and attaches the control information.

(2) Receiving a Fax

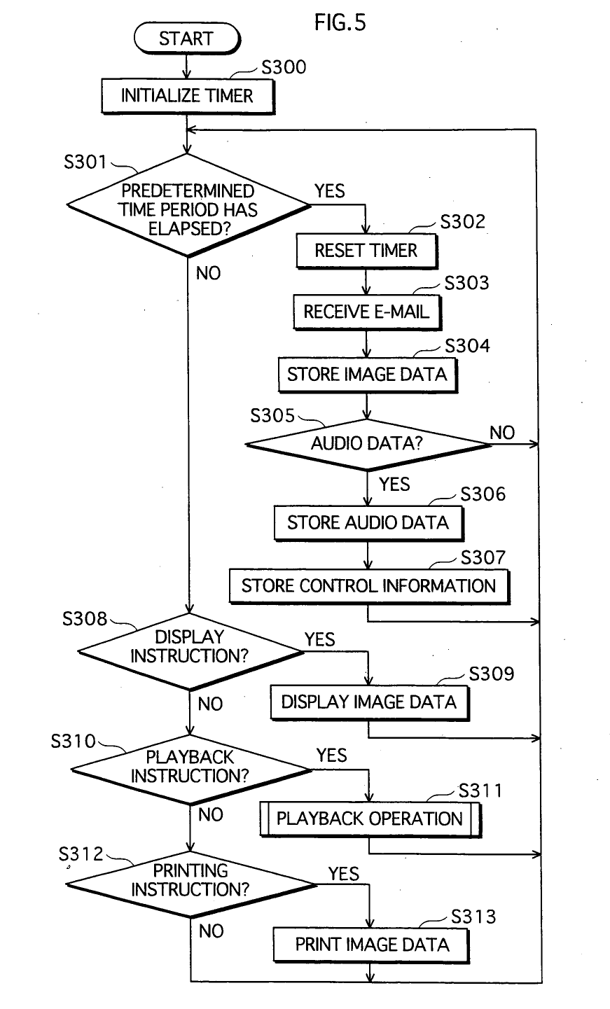

The following part describes an operation performed by the MFP 10a to receive a fax. FIG. 5 is a flowchart illustrating the operation performed by the MFP 10a to receive a fax. As shown in FIG. 5, when started, the MFP 10a initializes the timer included in the clock unit 214 (S300). This enables the clock unit 214 to send a notice to the e-mail receiving unit 213 when a predetermined time period has elapsed.

When the predetermined time period has elapsed, the clock unit 214 sends a notice to the e-mail receiving unit 213 (S301:YES). Then, the clock unit 214 resets the timer (S302). Again, this enables the clock unit 214 to send a notice to the e-mail receiving unit 213 when the predetermined time period has elapsed.

When the notice is sent, the e-mail receiving unit 213 in the MFP 10a accesses the e-mail server 11a, to retrieve an e-mail addressed to the MFP 10a (S303). The e-mail analyzing unit 212 retrieves image data attached to the e-mail, and the image data storing unit 210 stores the image data (S304).

If the e-mail analyzing unit 212 retrieves audio data from the e-mail (S305:YES), the audio data storing unit 208 stores the audio data in relation with the image data (S306). In addition, the e-mail analyzing unit 212 retrieves control information related to the audio data from the e-mail, and the control information storing unit 209 stores the control information (S307).

When receiving a display instruction to display image data stored in the image data storing unit 210, from the user through the operation panel unit 200, the MFP 10a reads the corresponding image data from the image data storing unit 210, and displays the image data on the liquid crystal panel unit 205 (S309). When receiving a playback instruction to output audio data stored in the audio data storing unit 208 as a sound, from the user through the operation panel unit 200 (S310:YES), the MFP 10a performs a playback operation (S311).

When receiving a printing instruction to print image data stored in the image data storing unit 210, from the user through the operation panel unit 200 (S312:YES), the printer unit 206 in the MFP 10a reads the corresponding image data from the image data storing unit 210, and prints the image data (S313).

(2-1) Playback Operation (S311)

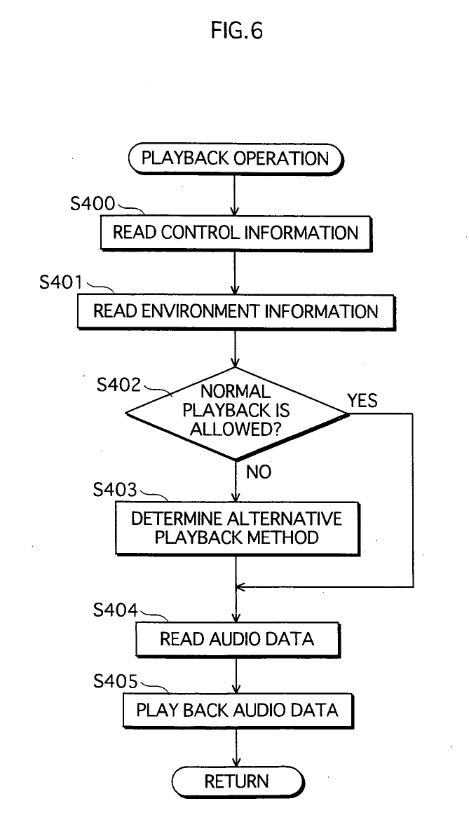

The following part describes the playback operation (S311) in detail. FIG. 6 is a flowchart illustrating the playback operation performed by the MFP 10a. As shown in FIG. 6, when receiving a playback instruction for audio data, the MFP 10a reads control information which is related to the audio data that is instructed to be played back, from the control information storing unit 209 (S400). Furthermore, the MFP 10a reads environment information from the environment information storing unit 211 (S401).

According to the first embodiment, the control information indicates a security level for the audio data and an alternative playback method in which the audio data is to be played back when normal playback is not permitted. Here, the security level is a standard to determine whether normal playback is permitted. The environment information indicates a security level for the MFP 10a. Here, the security processing unit 207 compares the security level indicated by the control information (hereinafter referred to as “SL0”) and the security level indicated by the environment information (hereinafter referred to as “SL1”). When SL1 is lower than SL0, the security processing unit 207 prohibits normal playback of the audio data.

When normal playback is prohibited (S402:NO), the security processing unit 207 reads the alternative playback method indicated by the control information (S403). After the alternative playback method is read, or when normal playback is permitted (S402:YES), the MFP 10a reads the audio data from the audio data storing unit 208 (S404). After this, the security processing unit 207 causes the speaker unit 201 to play back the audio data in the alternative playback method determined in the above manner (S405). Then, the playback operation goes back to a main routine.

When SL1 is lower than SL0, the audio data may be played back at a low volume or at fast speed. This can make it difficult for other people around the MFP 10a to hear a sound produced by playing back the audio data. Alternatively, only part of the audio data may be played back. Thus, information included in the rest of the audio data can be protected. Furthermore, a speaker of the audio data may be prevented from being identified by frequency conversion or the like. This can protect the privacy of the speaker.

1.4 Operations of the Mobile Telephones 19a to 19c

The following part describes an operation of the mobile telephone 19a. The following description serves as an explanation of operations of the mobile telephones 19b and 19c, since their operations are the same as the operation of the mobile telephone 19a.

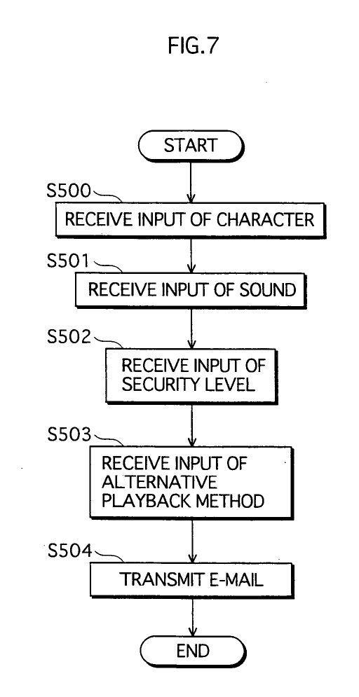

The mobile telephone 19a has functions which are the same as those of a normal mobile telephone. In addition to these functions, the mobile telephone 19a has an e-mail transmitting function. The mobile telephone 19a operates as follows when transmitting an e-mail to the MFP 10a and the like. FIG. 7 is a flow chart illustrating an operation performed by the mobile telephone 19a to transmit an e-mail. As shown in FIG. 7, the mobile telephone 19a receives an input of characters indicating a destination address and a message of an e-mail, from a user (S500). After this, the mobile telephone 19a receives an input of audio data which is to be attached to the e-mail, from the user (S501). Furthermore, the mobile telephone 19a receives a designation of a security level for the audio data (S502).

Subsequently, the mobile telephone 19a receives, from the user, a designation of an alternative playback method in which the audio data is to be played back when a security level of an MFP that plays back the audio data is lower than the security level designated in the step S502 (S503). Here, the mobile telephone 19a may present multiple alternative playback methods to make the user to select one of them. After this, the mobile telephone 19a transmits the e-mail according to an instruction made by the user.

### 2. Second Embodiment

The following describes a fax system relating to a second embodiment. As in the first embodiment, the following description serves as an explanation of an audio data communication system, an audio data transmission apparatus, an audio data reception apparatus, a composite data communication system, a composite data transmission apparatus and a composite data reception apparatus relating to the second embodiment of the present invention. The fax system relating to the second embodiment has the same construction as the fax system relating to the first embodiment, except for some constructions. Such constructions include a timing at which a security level of an MFP is checked and an operation performed when the security level of the MFP is not high enough. The following part describes the fax system relating to the second embodiment, with a main focus on its difference from the fax system relating to the first embodiment.

(1) Construction of MFP

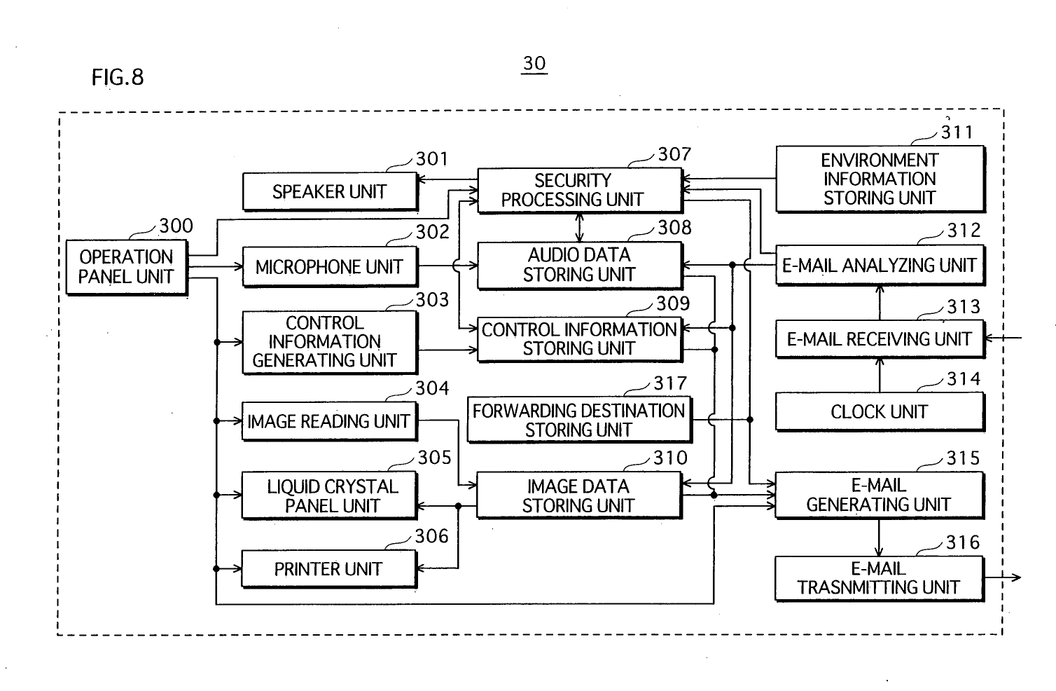

FIG. 8 is a functional block diagram illustrating main components of an MFP relating to the second embodiment. As seen from FIG. 8, an MFP 30 has a forwarding destination storing unit 317, in addition to an operation panel unit 300, a speaker unit 301, a microphone unit 302 and the like, which are common components to the MFP 10a. The forwarding destination storing unit 317 has a function of storing e-mail addresses.

(2) Operations of the MFP 30

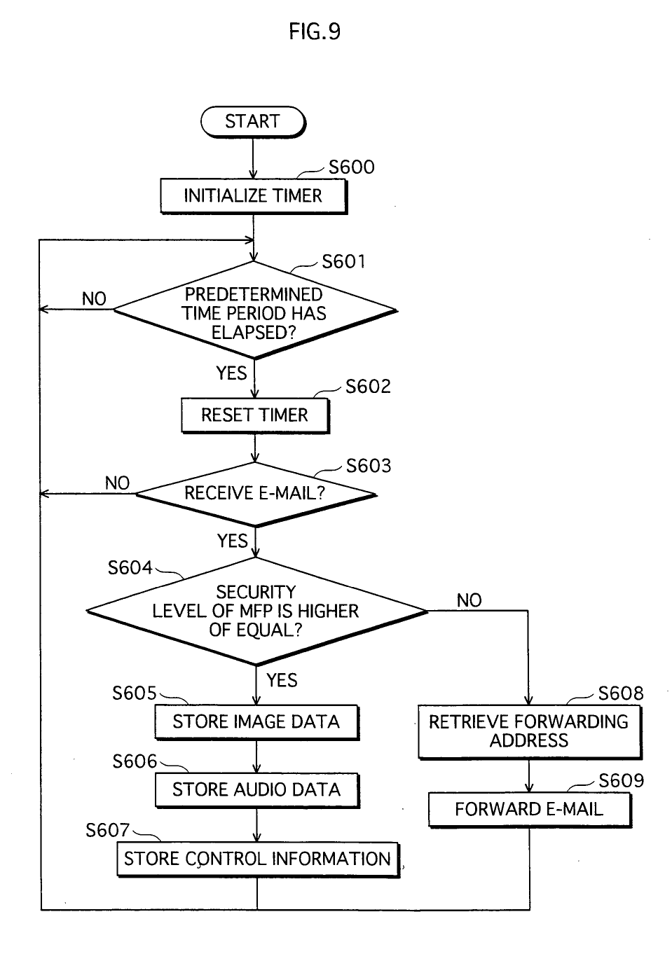

FIG. 9 is a flow chart illustrating an operation relating to a playback of a sound which is performed by the MFP 30. As shown in FIG. 9, a timer included in a clock unit 314 in the MFP 30 is initialized when the MFP 30 is started (S600). When a predetermined time period has elapsed (S601:YES), the clock unit 314 sends a notice to an e-mail receiving unit 313, and the timer is then reset (S602).

After this, the e-mail receiving unit 313 in the MFP 30 accesses an e-mail server. When the MFP 30 receives an e-mail (S603:YES), an e-mail analyzing unit 312 in the MFP 30 analyzes the received e-mail. When control information is attached to the e-mail, a security level indicated by the control information is compared with a security level of the MFP 30 which is stored in an environment information storing unit 311.

When the security level of the MFP 30 is lower than the security level indicated by the control information (S604:NO), an e-mail address is retrieved from the forwarding destination storing unit 317 (S608). After this, an e-mail transmitting unit 316 transmits the e-mail received in the step S603 to the e-mail address retrieved in the step S608 (S609).

When the security level of the MFP 30 is equal to or higher than the security level indicated by the control information (S604:YES), image data attached to the e-mail is stored in an image data storing unit 310 (S605). In addition, audio data attached to the e-mail is stored in an audio data storing unit 308 (S606), and the control information is stored in a control information storing unit 309 (S607).

(3) How to Determine a Forwarding Destination

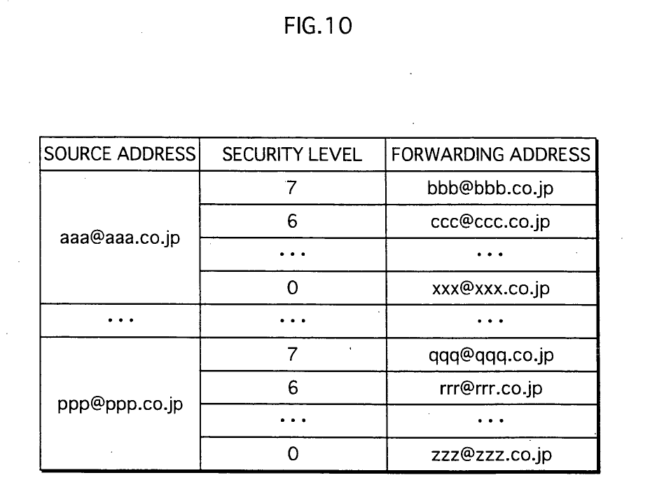

The following part describes how to determine a forwarding destination to which a received e-mail is forwarded. FIG. 10 illustrates a forwarding destination table stored in the forwarding destination storing unit 317. As shown in FIG. 10, the forwarding destination table shows a correspondence between a source address of an e-mail and a forwarding address. Here, a forwarding address can be selected depending on both a security level and a source address. To be specific, when a source address of an e-mail is aaa@aaa.co.jp and a security level of the e-mail is “7”, bbb@bbb.co.jp is selected as a forwarding address.

As described above, when the security level of the MFP 30 is lower than an level indicated by control information attached to a received e-mail, the e-mail can be forwarded to a device which is more appropriate for playing back audio data attached to the e-mail. Thus, even if the audio data is played back, leakage of information in the audio data can be prevented.

### 3. Modification Examples

It should be noted that the present invention is not limited to the first and second embodiments described above. The present invention includes the following modification examples.

(1) According to the first and second embodiments, control information indicates a security level, as an example. However, the present invention is not limited to such. Control information may additionally indicate the following information.

Control information may indicate a maximum number of times audio data is permitted to be played back. In this case, every time audio data is played back, an MFP (10a, 10b and 30) may add one to a value showing the number of times the audio data has been played back. If the number of times the audio data has been played back becomes equal to the maximum number, the MFP (10a, 10b and 30) no longer plays back the audio data.

Furthermore, control information may indicate a time limit for normal playback of audio data. In this case, the MFP (10a, 10b and 30) refers to a calendar and the time limit, prior to playing back the audio data. If a current date is before the time limit, the MFP (10a, 10b and 30) plays back the audio data. If not, the MFP (10a, 10b and 30) does not play back the audio data.

Here, if the number of times the audio data has been played back becomes equal to the maximum number, or if the current date exceeds the time limit, the audio data may be deleted from an audio data storing unit (208 and 308).

(2) An alternative playback method of audio data which is indicated by control information is, as an example, described in detail in the following.

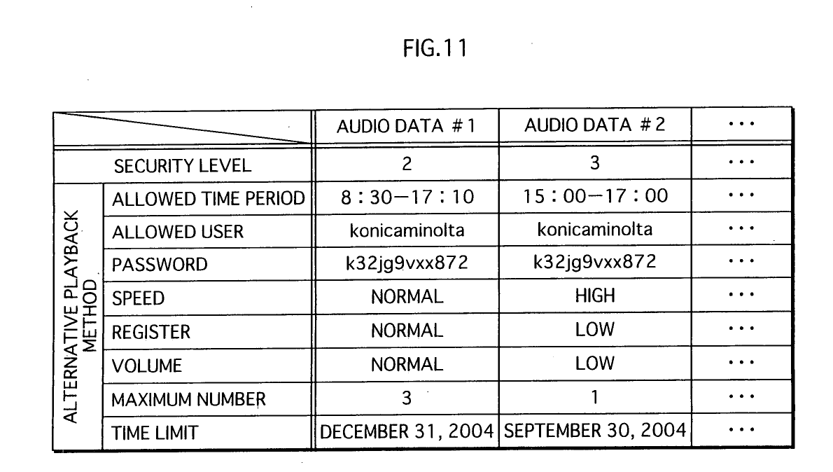

FIG. 11 illustrates, as an example, an alternative playback method indicated by control information. When a plurality of pieces of audio data (audio data #1, audio data #2, . . . ) are attached to an e-mail, a different alternative playback method may be assigned to each of the pieces of audio data, as shown in FIG. 11.

As shown in FIG. 11, a security level of the audio data #1 is set to two. When a security level of the MFP (10a, 10b and 30) is lower than two, the audio data #1 is only allowed to be played back, during a time period from 8:30 to 17:10, by a user under the name of konicaminolta, with an input of an authentication password of k32jg9vxx872, at normal speed, in a normal register, at a normal volume, three times at most, and on or before Dec. 31, 2004.

A security level of the audio data #2 is set to three. When the security level of the MFP (10a, 10b and 30) is lower than three, the audio data #2 is only allowed to be played back, during a time period from 15:00 to 17:00, by a user under the name of konicaminolta, with an input of an authentication password of k32jg9vxx872, at high speed, in a low register, at a low volume, only once, and on or before Sep. 30, 2004.

In this way, the audio data #1 and #2 can be played back in an appropriate alternative playback method which is determined in accordance with the security level of the MFP (10a, 10b and 30). This can prevent information leakage that occurs due to normal playback of the audio data #1 and #2.

Alternatively, one common alternative playbackmethod may be assigned to a plurality of pieces of audio data attached to an e-mail. Here, items to define an alternative playbackmethod are not limited to those described above. The number of the items may be increased or decreased. For example, a specific sound in audio data may not be played back, or audio data may be played back in a discontinuous manner. Furthermore, a playback range may be limited. For example, a predetermined length of audio data from its start may only be allowed to be played back.

(3) According to the first and second embodiments, the environment information storing unit (211 and 311) stores a fixed value, which indicates the security level of the MFP (10a, 10b and 30). This construction may be modified as follows.

An operation history of the MFP (10a, 10b and 30) is stored. When a user instructs the MFP (10a, 10b and 30) to play back audio data, or when the MFP (10a, 10b and 30) receives an e-mail, the security level of the MFP (10a, 10b and 30) is determined based on the operation history.

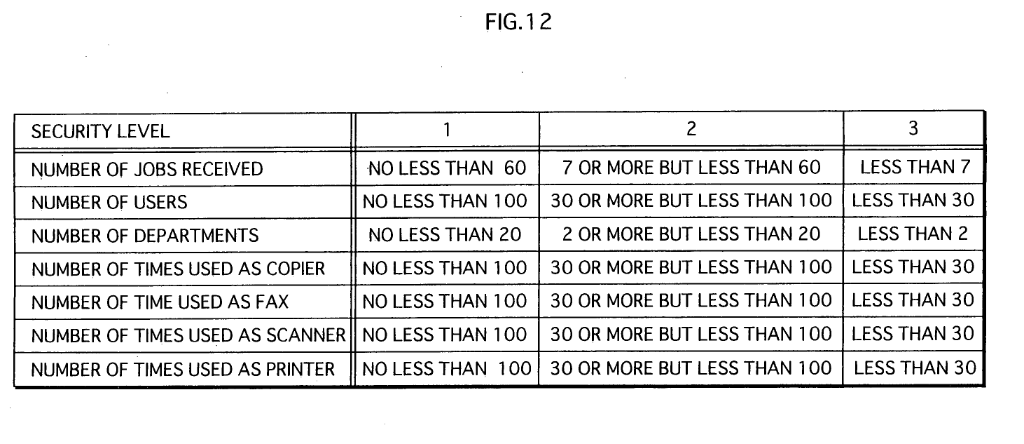

FIG. 12 is a security level determination table, which is used to determine the security level of the MFP (10a, 10b and 30) based on its operation history. As shown in FIG. 12, the security level is set to one when one of the following conditions is satisfied: the number of jobs received per hour is 60 or more; the number of users per day is 100 or more; the number of departments using the MFP in a company is 20 or more; the number of times the MFP is used as a copier per day is 100 or more; the number of times the MFP is used as a fax per day is 100 or more; the number of times the MFP is used as a scanner per day is 100 or more; and the number of times the MFP is used as a printer per day is 100 or more.

The security level is set to two when none of the above conditions are met, but when one of the following conditions is satisfied: the number of jobs received per hour is seven or more; the number of users per day is 30 or more; the number of departments using the MFP in a company is two or more; the number of times the MFP is used as a copier per day is 30 or more; the number of times the MFP is used as a fax per day is 30 or more; the number of times the MFP is used as a scanner per day is 30 or more; and the number of times the MFP is used as a printer per day is 30 or more.

The security level is set to three when none of these conditions are met, but when all of the following conditions are satisfied: the number of jobs received per hour is less than seven; the number of users per day is less than 30; the number of departments using the MFP in a company is less than two; the number of times the MFP is used as a copier per day is less than 30; the number of times the MFP is used as a fax per day is less than 30; the number of times the MFP is used as a scanner per day is less than 30; and the number of times the MFP is used as a printer per day is less than 30.

If the security level is determined in the above-described manner, an alternative play back method for audio data can be determined according to recent operations performed by the MFP (10a, 10b and 30). This can prevent information leakage in accordance with recent operations of the MFP (10a, 10b and 30).

Here, each MFP (10a, 10b and 30) may prestore a predetermined security level determination table, or may receive a security level determination table as an attachment to an e-mail along with audio data. In addition, criteria to determine a security level are not limited to those described above. The number of the criteria may be increased by adding a criterion that is not mentioned in FIG. 12, for example, a model number of the MFP (10a, 10b and 30). Alternatively, the number of the criteria may be decreased.

(4) When an e-mail is forwarded, it may be recorded in a history. This will help identify a cause of a security problem.

(5) According to the second embodiment, the MFP 30 judges whether an e-mail needs to be forwarded or not on reception of the e-mail. The present invention is not limited to such. Instead, the MFP 30 may judge whether an e-mail needs to be forwarded or not on reception of an instruction to play back audio data attached to the e-mail, from a user. This means that the security level of the MFP 30 is checked on reception of the playback instruction. This modification is preferable for a case where the security level of the MFP 30 vary as in the modification example (3). The reason for this is explained in the following. Although the security level of the MFP 30 may not be high enough when the MFP 30 receives the e-mail, the security level of the MFP 30 may become sufficiently high when the MFP 30 receives the playback instruction, and vice versa.

According to the first embodiment, when the security level of the MFP (10a and 10b) is lower than a security level indicated by control information attached to an e-mail, audio data attached to the e-mail is to be played back in an alternative playback method indicated by the control information. However, when the audio data can not be played back in the alternative playback method, or the control information indicates no alternative playback method, the e-mail may be forwarded. This can prevent information leakage more reliably.

(6) According to the second embodiment, it is the MFP 30 which determines a forwarding destination of a received e-mail and transmits the e-mail to the forwarding destination. The present invention is not limited to such.

The MFP 30 may only judge whether a received e-mail needs to be forwarded or not. If judged in the positive, the MFP 30 may transmit the e-mail to a predetermined forwarding device. In this case, it is the forwarding device which determines a forwarding destination, and transmits the e-mail to the forwarding destination. This enables the forwarding device to integrally manage tables used to determine a forwarding destination. Thus, it becomes easier to manage the tables.

In this case, an e-mail server may function as the forwarding device. Furthermore, the forwarding device may have a plurality of forwarding destinations. A forwarding device may also store and manage a history of a forwarding operation.

Furthermore, information used to determine a forwarding destination may be attached to an e-mail, to be transmitted. In this case, the MFP 30 may transmit the information to the forwarding device together with the e-mail. Thus, the forwarding device does not need to manage a forwarding destination table used to determine a forwarding destination. This enhances convenience.

(7) A forwarding destination of an e-mail is not limited to an MFP. A forwarding destination can be any device which can receive and e-mail and play back audio data attached to the e-mail. Such a device is, for example, a mobile telephone.

(8) According to the first and second embodiments, leakage of information included in audio data is prevented. However, effects of the present invention are not limited to such. The present invention is applicable to prevent leakage of information included in other types of data, such as still image data, moving image data, and a special signal.

If such is the case, a security level may be determined in a different way, and a different forwarding destination may be selected for each type of data. Furthermore, different items may be selected to define an alternative playback method for each type of data. In the case of image data, for example, a color balance, a resolution or a display range may be changed for each alternative playback method.

(9) A case is assumed where a security level of the MFP (10a, 10b and 30) is lower than a security level indicated by control information in a relative manner. Here, if the security level of the MFP (10a, 10b and 30) is high in an absolute manner, audio data may be played back in an alternative playback method which is less restricted. For example, a playback range for the audio data may be increased. If the security level of the MFP (10a, 10b and 30) is low in an absolute manner, audio data may be played back in an alternative playback method which is more secure. For example, a playback range for the audio data may be reduced.

(10) The audio data storing unit (208 and 308) may store audio data in the following manner.

If audio data is prohibited from being played back in terms of conditions shown by an alternative playback method, the audio data may be deleted. Specifically speaking, if audio data has been played back at an equal number of times to a maximum number of times the audio data is allowed to be played back, or a time limit for playing back audio data is exceeded, the audio data may be deleted from the audio data storing unit (208 and 308). This enables the audio data storing unit (208 and 308) to be efficiently used, since a risk that new audio data can not be stored because of a shortage of an available capacity.

(11) According to the first and second embodiments, the MFP (10a, 10b and 30) includes the operation panel unit (200 and 300) and the microphone unit (202 and 302). However, the present invention is not limited to such.

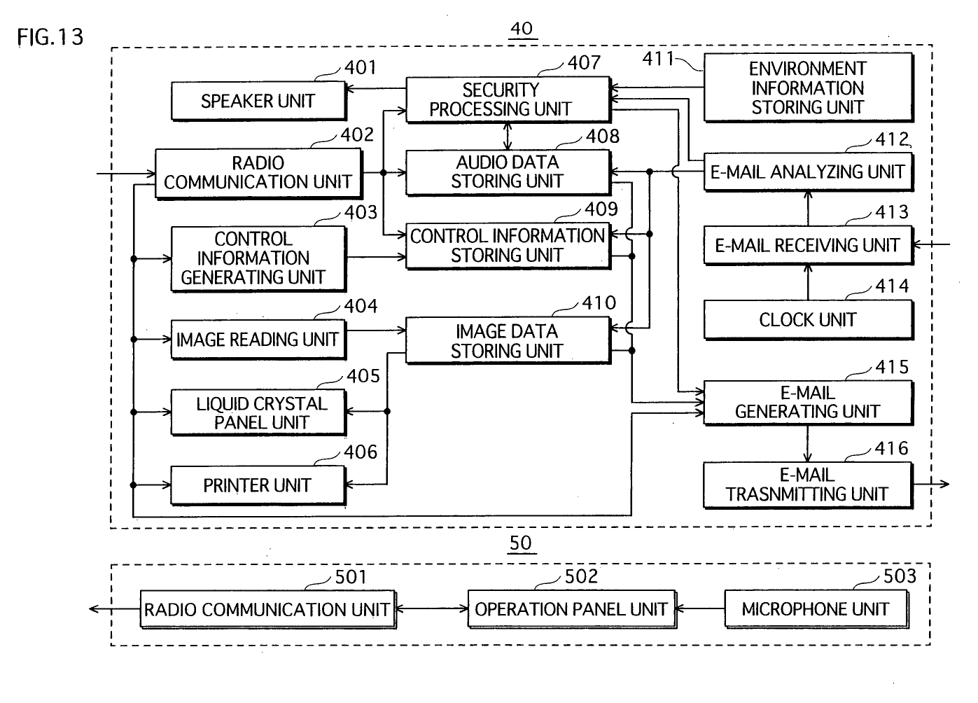

FIG. 13 is a functional block diagram illustrating a construction of an MFP relating to a modification example (11). As shown in FIG. 13, an MFP 40 includes a speaker unit 401, a radio communication unit 402, a control information generating unit 403 and the like as in the first and second embodiments. However, the MFP 40 does not include an operation panel unit and a microphone unit.

A remote controller 50 includes a radio communication unit 501, an operation panel unit 502, and a microphone unit 503. The radio communication unit 501 has a function of communicating wirelessly with the radio communication unit 402 in the MFP 40. According to the modification example (11), the remote controller 50 receives an input from a user, and the radio communication unit 501 transmits the user's input to the MFP 40. When the radio communication unit 402 receives the user's input, the MFP 40 operates in the same manner as in the first and second embodiments.

Here, the remote controller 50 may be a mobile telephone. If such is the case, the radio communication unit 402 may perform communication in conformity with the Bluetooth standard (registered trademark). Furthermore, the radio communication unit 402 may be replaced with a modem, so that the modem communicates with the remote controller 50 through a telephone line.

Alternatively, it may be only the microphone unit (202 and 302) for receiving an input of audio data which is separated from the MFP (10a, 10b and 30). Furthermore, a remote controller may additionally include a camcorder to receive an input of moving image data. When a remote controller is a mobile telephone, a camera mounted with the mobile telephone may be used to obtain image data.

(12) According to the first and second embodiments, control information is generated by the MFP (10a, 10b and 30), which attaches audio data to an e-mail and transmits the e-mail. However, the present invention is not limited to such.

Alternatively, although control information is generated at a transmitting MFP in accordance with an instruction from a user of the transmitting MFP, a user of a receiving MFP may be able to change the control information. In this case, it is preferable that the change is allowed only when a predetermined password is received, to prevent information leakage.

In this way, even when audio data is prohibited from being played back normally, a user who is granted with a predetermined access right is allowed to play back the audio data normally. This is desirable when the user must check what is included in the audio data for some reason. As a result, the modification example (12) provides more convenience to users without undermining the effects of the present invention.

(13) When the audio data storing unit (208 and 308), the image data storing unit (210 and 310) and the control information storing unit (209 and 309) do not have an enough available space, the storing units (208, 209, 210, 308, 309 and 310) may be prohibited to store more data. This can prevent a loss of important data that has been stored. Alternatively, a level of importance may be associated with each piece of data. Thus, when the storing units (208, 209, 210, 308, 309 and 310) receive new data but do not have an enough available space, data which have a lower level of importance than the received new data is deleted, to secure a necessary space.

Alternatively, data which has been the least recently played back, or data which has been the least recently received may be deleted to secure a necessary space.

(14) Control information attached to an e-mail may indicate an IP address or the like to specify a location at which audio data related to the control information is allowed to be played back normally. Thus, the control information can prohibit playback of the audio data when the e-mail is forwarded to an MFP which is not suitable for normal playback of the audio data in a viewpoint of a user who has transmitted the e-mail, or when the e-mail is transmitted to a wrong destination. As a result, the user who has transmitted the e-mail can have more control over prevention of information leakage.

Although the present invention has been fully described by way of examples with reference to the accompanying drawings, it is to be noted that various changes and modifications will be apparent to those skilled in the art.

Therefore, unless otherwise such changes and modifications depart from the scope of the present invention, they should be construed as being included therein.

What is claimed is:

1. An audio data communication system including a transmission apparatus and a reception apparatus,
the transmission apparatus comprising:
a generating unit operable to generate control information indicating a condition to play back audio data; and
a transmitting unit operable to transmit the audio data and the control information, and
the reception apparatus comprising:
a receiving unit operable to receive the audio data and the control information;
a determination unit operable to determine a method to play back the audio data, based on the condition indicated by the control information and a security level of the reception apparatus; and
a playback unit operable to play back the audio data in accordance with the method determined by the determination unit.

2. The audio data communication system of claim 1, wherein
the reception apparatus further includes:
a determining unit operable to determine a forwarding destination of the audio data, based on the control information and the security level of the reception apparatus; and
a forwarding unit operable to forward the audio data to the forwarding destination.

3. The audio data communication system of claim 2, wherein
the reception apparatus further includes:
a storing unit operable to store the audio data, if the forwarding unit fails to forward the audio data.

4. The audio data communication system of claim 3, wherein
the playback unit is permitted to play back the audio data when a predetermined time period has elapsed after the failure.

5. The audio data communication system of claim 3, wherein
the playback unit is permitted to play back the audio data, if an amount of audio data stored in the storing unit exceeds a predetermined amount.

6. The audio data communication system of claim 3, wherein
the reception apparatus deletes the audio data from the storing unit when a predetermined time period has elapsed after the failure.

7. The audio data communication system of claim 3, wherein
when an amount of audio data stored in the storing unit exceeds a predetermined amount, the reception apparatus deletes audio data which is the least recently stored in the storing unit.

8. The audio data communication system of claim 3, wherein
when an amount of audio data stored in the storing unit exceeds a predetermined amount, the reception apparatus stops receiving audio data.

9. The audio data communication system of claim 3, wherein
if the receiving unit receives only the audio data, the forwarding unit forwards the received audio data to a predetermined forwarding destination.

10. The audio data communication system of claim 3, wherein
the forwarding destination is a mobile telephone.

11. The audio data communication system of claim 3, wherein
the transmission apparatus further includes:
a recording unit operable to record the audio data, the recording unit being removable from the transmission apparatus.

12. The audio data communication system of claim 1, wherein
the control information indicates at least one of a location at which the audio data is permitted to be played back, an apparatus at which the audio data is permitted to be played back, a time at which the audio data is permitted to be played back, volume at which the audio data is permitted to be played back, speed at which the audio data is permitted to be played back, a register in which the audio data is permitted to be played back, and a part of the audio data which is permitted to be played back.

13. An audio data transmission apparatus comprising:
a generating unit operable to generate control information indicating a condition to play back audio data; and
a transmitting unit operable to transmit the audio data and the control information.

14. An audio data reception apparatus comprising:
a receiving unit operable to receive audio data and control information indicating a condition to play back the audio data;
a determination unit operable to determine a method to play back the audio data, based on the condition indicated by the control information and a security level of the reception apparatus; and
a playback unit operable to play back the audio data in accordance with the method determined by the determination unit.

15. A composite data communication system for composite data including a combination of image data and audio data, the composite data communication system including a transmission apparatus and a reception apparatus,
the transmission apparatus comprising:
a generating unit operable to generate control information indicating a condition to play back audio data included in composite data; and
a transmitting unit operable to transmit the composite data and the control information, and
the reception apparatus comprising:
a receiving unit operable to receive the composite data and the control information;
a determination unit operable to determine a method to play back the audio data, with reference to the condition indicated by the control information and a security level of the reception apparatus; and
a playback unit operable to play back the audio data in accordance with the method determined by the determination unit.

16. The composite data communication system of claim 15, wherein
the transmitting unit attaches image data included in the composite data, to an e-mail in accordance with an Internet fax standard, attaches the audio data included in the composite data and the control information to the e-mail, and transmits the e-mail to the reception apparatus, and
the receiving unit receives the e-mail in accordance with the Internet fax standard.

17. A composite data transmission apparatus that transmits composite data including a combination of image data and audio data, comprising:
a generating unit operable to generate control information indicating a condition to play back audio data included in composite data; and
a transmitting unit operable to transmit the composite data and the control information.

18. The composite data transmission apparatus of claim 17, wherein
the transmitting unit attaches image data included in the composite data, to an e-mail in accordance with an Internet fax standard, attaches the audio data included in the composite data and the control information to the e-mail, and transmits the e-mail to the reception apparatus.

19. A composite data reception apparatus that receives composite data including a combination of image data and audio data, comprising:
a receiving unit operable to receive composite data and control information indicating a condition to play back audio data included in the composite data;
a determination unit operable to determine a method to play back the audio data, based on the condition indicated by the control information and a security level of the reception apparatus; and
a playback unit operable to play back the audio data in accordance with the method determined by the determination unit.

20. The composite data reception apparatus of claim 19, wherein
the receiving unit receives the e-mail in accordance with the Internet fax standard.
